(19) United States
(12) Patent Application Publication
(10) Pub. No.: US 2012/0180810 A1
(43) Pub. Date: Jul. 19, 2012

(54) CLEANING OF A PROCESS CHAMBER

(75) Inventors: Rudolf Beckmann, Hammersbach (DE); Michael Geisler, Wachtersbach (DE); Harald Rost, Gelnhausen (DE)

(73) Assignee: LEYBOLD OPTICS GMBH, Alzenau (DE)

(21) Appl. No.: 13/386,711

(22) PCT Filed: May 28, 2010
(86) PCT No.: PCT/EP2010/003247

§ 371 Date: Mar. 26, 2012

(30) Foreign Application Priority Data
Jul. 26, 2009 (DE) 10 2009 035 045.4
Feb. 18, 2010 (DE) 10 2010 008 499.9

(51) Int. Cl. B08B 7/00; B05C 5/00

(52) U.S. Cl. 134/1.1; 156/345.43

(57) ABSTRACT

A method for cleaning at least one component arranged in the inner region of a plasma process chamber using a cleaning gas including fluorine gas, where the process chamber has at least one electrode and counter-electrode for generating a plasma for plasma treatment, where the inner region is exposed to gaseous fluorine compounds with a partial pressure of greater than 5 mbar, where the process chamber has at least one electrode and counter-electrode for generating a plasma, and the fluorine gas is thermally activated by means of a temperature-regulating means, where the component to be cleaned has a temperature of<350° C.

### TECHNICAL FIELD

The invention relates to a method and to a process chamber

### BRIEF DISCUSSION OF RELATED ART

Substrates for electronic or optoelectronic applications, for example semiconductor elements or else solar cells, are preferably treated in process chambers by means of PVD, CVD or PECVD methods (PVD: physical vapor deposition; CVD: chemical vapor deposition; PECVD: plasma enhanced chemical vapor deposition), wherein reaction gases are introduced into the process chamber, and are deposited on the substrate.

WO 2009/0033552 discloses a treatment system for the plasma coating of large-area substrates, wherein the substrate area can be of a size of 1 m² or more. The plasma is generated in a process chamber between an electrode and a counter-electrode between which the substrate to be treated is introduced. A reaction gas is supplied by means of a gas spray integrated into the electrode. The gas spray comprises a gas spray exit plate having a multiplicity of exit openings with the aid of which the reaction gas is conducted uniformly into the process chamber.

The coating speed and quality of the plasma deposition are dependent on a number of process parameters, in particular on pressure, flow rate and composition of the reaction gases, power density and frequency of the plasma excitation, the substrate temperature, and also the distance between electrode and counter-electrode or the distance between the substrate surface and the respective counter-electrode.

What is disadvantageous about these coating methods is that the reaction gases are not just deposited on the substrate, and partial regions of the process chamber are also coated in this case. The coating of the process chamber can have the effect that particles detach from this coating and the substrate is contaminated. If such contamination of the substrate occurs, losses of quality in the coating should be reckoned with.

It is therefore important to clean the process chamber of coatings. For this purpose, a, preferably caustic, cleaning gas is introduced into the process chamber, and cleans the contaminated surfaces. Since no coating is possible in the vacuum chamber during the cleaning itself and also for a certain time after the cleaning, it is desirable to carry out this cleaning as rapidly as possible.

The prior art discloses essentially two cleaning methods. During in-situ cleaning, a cleaning gas is excited directly in the process chamber, while in remote-plasma cleaning, the cleaning gas is excited in an external device and an excited cleaning gas is introduced at low pressure into the process chamber.

At the present time, nitrogen trifluoride NF3 is primarily used as cleaning gas. The fluorine species or fluorine radicals provided via the excitation of nitrogen trifluoride can detach the silicon compounds used for the coating of solar cells, such as e.g. silicon dioxide, silicon oxide nitride and/or silicon nitride, from the contaminated surfaces. However, nitrogen trifluoride is an environmentally hazardous gas which acts as a greenhouse gas and has an atmospheric half-life of several hundred years. Moreover, nitrogen trifluoride is very expensive since demand has risen significantly in recent years.

In order to replace nitrogen trifluoride, it has been proposed in the prior art to use other fluorine gas mixtures, such as, for example, tetrafluoromethane CF4, sulfur hexafluoride SF6, or a mixture of argon, nitrogen and fluorine Ar/N₂/F₂. In particular, the document EP 1 138 802 A2 discloses using a cleaning gas comprising a content of at least 50% by volume of molecular fluorine, wherein, at a chamber pressure of between 370 mT and 450 mT, the chamber or at least the objects to be cleaned within the chamber are brought to an increased temperature of approximately 450° C.

### BRIEF SUMMARY

The invention provides cleaning of surfaces of a component of an interior of a process chamber which dispenses with the use of nitrogen trifluoride, but enables fast and effective cleaning.

The method according to the invention for cleaning a surface of at least one component arranged in the inner region of a process chamber by means of exposure to a cleaning gas comprising fluorine gas, wherein the process chamber at least one electrode and counter-electrode for generating a plasma for the plasma treatment of a substrate, is distinguished by
exposing the component to be cleaned to fluorine gas and/or gaseous fluorine compounds with a total partial pressure of greater than 5 mbar and/or
thermally activating the fluorine gas and/or gaseous fluorine compounds and
regulating the temperature of the component to be cleaned to a temperature of <350° C.

In particular, but not necessarily, the process chamber is set up and designed for the CVD or PECVD treatment of flat substrates having a surface area of more than 1 m². It is preferred if substrate, electrode and counter-electrode have a flat surface. Preferably, said surfaces is/are planar. It goes without saying that the substrate, electrode and counter-electrode can also have concave or convex surfaces.

During the production of amorphous or microcrystalline coatings, a process gas pressure of between 100 Pa and 2000 Pa, in particular 1300 Pa, and a power density of between 0.01 W/cm³ and 5 W/cm³ in particular 1 W/cm³, are preferred. The output power of the RF generator is in a range of between 50 W and 50 kW, preferably 1 kW. The excitation frequency is in a range of between 1 MHz and 150 MHz, preferably 13.56 MHz.

It is proposed according to the invention to use fluorine gas, or—on account of its easier usability—a fluorine gas mixture, as cleaning gas, wherein the total partial pressure in the inner region of the chamber, at least in partial regions of the process chamber, is greater than 5 mbar, preferably greater than 20 mbar. Molecular fluorine is preferably used, but atomic fluorine can also be used.

It has surprisingly been found that the cleaning rate can be significantly increased by the high partial pressures according to the invention of the fluorine gas or of the gaseous fluorine compounds. In this case, the surface of the component is preferably cleaned of a contamination or parasitic coating with silicon compounds used during production, for example of solar cells, such as, e.g. silicon dioxide, silicon oxide nitride and/or silicon nitride. However, application to other contaminations is also conceivable.

A total partial pressure of between 20 mbar and 1000 mbar has proved to be particularly advantageous, wherein very good results can already be obtained with a partial pressure of 250-500 mbar. The cleaning gas can be supplied with a fluorine partial pressure of between 20 mbar and 1000 mbar and/or brought to the abovementioned fluorine compound partial pressure of between 20 mbar and 1000 mbar in the process chamber.

The cleaning gas can be chosen as fluorine gas or as fluorine gas in a carrier gas, for example an inert gas such as nitrogen or argon, with a molar concentration of fluorine of 1%, 10%, 20%, 30% or more in the carrier gas.

A further aspect of the invention proposes a method for cleaning at least one component arranged in the inner region of a process chamber, which method is distinguished by the fact that the fluorine gas is thermally activated preferably by means of a temperature-regulating means, wherein the component to be cleaned has a temperature of <350° C. In this method, therefore, the component to be cleaned is exposed to cleaning gas comprising thermally activated fluorine, wherein, in contrast to customary thermal etching, the component to be cleaned, or the surface thereof, is not heated or is heated only to a relatively small extent, particularly in comparison with the heating of the component during the plasma treatment, for example a PECVD or CVD coating.

In accordance with this aspect of the invention as well, the component is in this case cleaned of a contamination or coating with silicon compounds, such as, e.g. silicon dioxide, silicon oxide nitride and/or silicon nitride. However, in this case, too, application to other contaminations is conceivable.

In particular, the component to be cleaned has a temperature of <250° C., <200° C., <150° C., <100° C. or between 20° C. and 60° C. The thermal activation of the cleaning gas can be effected via the contact of the cleaning gas with a heated surface having a higher temperature than the component to be cleaned itself. It goes without saying that thermal activation can also be effected outside the process chamber, for example in a pipe section heated to, in particular, a temperature of >350° (Remote Thermal Activation).

It is thus proposed to thermally activate the fluorine gas for cleaning purposes, although—in contrast to conventional thermal etching—the component to be cleaned has relatively low temperatures. It has surprisingly been found that such thermal activation of the fluorine makes it possible to clean surfaces in the interior of the process chamber and to effectively reduce the contamination of the substrate with residues or parasitic coatings, particularly if the component to be cleaned is chosen suitably. The particularly critical regions for parasitic coatings of the process chamber include the electrodes for plasma generation, particularly if the latter has an outlet, for example an integrated gas spray for reaction gases, which is susceptible to a coating and therefore has to be cleaned with a high degree of dependability and completeness.

The method described can be combined with thermal etching. Thermal etching is understood here to be the etching of an article or of a surface at an elevated temperature of the article or of the surface, wherein an increase in the etching rate as the temperature of the surface to be etched increases is utilized. In accordance with a further preferred exemplary embodiment, therefore the cleaning effect can be increased further if parts of the process chamber, in particular parts of the process chamber which are particularly susceptible to parasitic coatings, are heated before or during cleaning.

If at least one component to be cleaned is an electrode, counter-electrode and/or a gas distributor, and/or at least one electrode, counter-electrode and/or a gas distributor are/is used as temperature-regulating means for thermally activating the fluorine gas, the cleaning of components that are particularly critical with regard to parasitic coating is effected by spatially closely situated temperature-regulating means. It goes without saying that different components can be brought to different temperatures. By way of example, an external temperature-regulating means can be brought to an elevated temperature, for example to a temperature of >350° C., while the electrode is brought to a temperature in the range of 20° C.-80° C. and the counter-electrode is brought to 180° C.

If, prior to exposure to the cleaning gas, by means of a plasma treatment, a substrate is coated with a layer comprising silicon and a residue comprising silicon is formed at least on the component to be cleaned, an integrated coating and cleaning process can thus be made available.

If, during exposure to the cleaning gas, the component to be cleaned has a temperature which is at most 1.8 times the temperature of the component during the plasma treatment, preferably less than 60° C., particularly preferably less than 20° C., it is thus possible to reduce the thermal loading of the component to be cleaned and also the required use of energy during cleaning.

The method can also be used if, prior to exposure to the cleaning gas, a substrate with a layer comprising silicon is etched and a residue comprising silicon is formed at least on the component to be cleaned.

At least one partial region of the electrode, of the counter-electrode, of a gas distributor assigned to the electrode, of a substrate bearing surface assigned to the counter-electrode or of a boiler wall surface of the process chamber can be chosen as the surface to be cleaned and/or, during exposure to the cleaning gas, the surface to be cleaned has a temperature which is at most 1.8 times the temperature of the surface during the plasma treatment, preferably less than 60° C., particularly preferably less than 20° C.

By preventing the formation of a residue on a surface region of the electrode, of the counter-electrode, of the gas distributor, of the substrate bearing surface and/or of a boiler wall surface of the process chamber, what can be achieved is that critical regions are not even contaminated in the first place and the cleaning by means of the cleaning gas can thus be restricted cost-effectively to partial regions. The covering can be effected by structural-mechanical covering means or structural-electrical covering means, wherein the latter use the fact that a contamination does not take place when a surface lies in the region of a dark space shield, in which no plasma can form.

If the substrate is arranged on a bearing surface during the plasma treatment, the substrate bearing surface is covered, in particular, such that said surface is not contaminated. In particular, the covering by the substrate can be effected in such a way that the formation of a residue on the substrate bearing surface is prevented during the plasma treatment. The covering reduces the time required for the cleaning and reduces the required quantity of gas for the cleaning. Furthermore, the preferably large-area bearing surface can be heated or subjected to thermal treatment and thus serve as means for thermally activating the cleaning gas, in particular the fluorine gas.

In particular, at least partial surfaces of mounting means can be chosen as the surface to be cleaned, wherein the mounting means are assigned to the substrate bearing surface. The mounting means serve for mounting the substrate during plasma treatment. In particular, the mounting means can be thermally and/or electrically insulated from the bearing surface, such that, while the bearing surface is brought to an elevated temperature, for example of >350° C., the mounting means are at a temperature of <350° C., in particular <80° C., or in a range of between 20° C. and 60° C.

If, during exposure to the cleaning gas, a distance in a range of between 2 mm and 100 mm is set between a gas exit plate of a gas distributor assigned to the electrode and the counter-electrode, the cleaning gas can act both on the region of the electrode and on that of the counter-electrode. It is particularly advantageous in this case if the counter-electrode is heated, while the electrode and/or the gas distributor are/is at a lower temperature, for example a temperature in the range of the temperature during the plasma treatment, in particular the coating. The bearing surface can be assigned to the counter-electrode and likewise, or else independently of the counter-electrode, heated and thus enable, as described above, thermal activation of the cleaning gas in a particularly simple manner.

If alongside fluorine gas an inert gas, in particular nitrogen or argon, is used in the cleaning gas, this facilitates the handling of the method since gas mixtures of this type can be controlled more simply with regard to corrosion of the chamber components and line systems. Argon additionally has the advantage that it does not form compounds with coating constituents, in particular silicon, and dust contaminations, as in the case of nitrogen, should therefore not be expected.

If a plasma excitation of the cleaning gas within and/or outside (remote plasma cleaning) the process chamber is effected, such that excited fluorine species are formed, the reactivity of the cleaning gas can be increased further.

The process chamber according to the invention having at least one electrode and counter-electrode for generating a plasma for the plasma treatment of a substrate is designed and intended for performing a method as claimed in any of the preceding claims, wherein

means for exposing the component to be cleaned to fluorine gas or gaseous fluorine compounds with a total partial pressure of greater than 5 mbar and/or

means for thermally activating the fluorine gas or gaseous fluorine compounds and for regulating the temperature of the component to be cleaned to a temperature of <350° C. are provided.

The apparatus according to the invention for the plasma treatment of a substrate comprises in one embodiment
means for exciting a capacitively coupled having plasma discharge in a region between an electrode and a counter-electrode and
means for transporting a quantity of at least one activatable gas species into a region of the plasma discharge, wherein
the substrate is arranged or can be arranged between the electrode and the counter-electrode between a substrate surface region to be treated and the electrode.

The plasma discharge is effected, in particular, at an excitation frequency of between 1 MHz and 150 MHz, preferably 13.56 MHz. Preferably, either the electrode or the counter-electrode is at or can be connected to ground potential. However, arrangements having a floating electrode and/or counter-electrode are also conceivable.

In particular, a control device is provided, which controls a pump apparatus for supplying and discharging the cleaning gas and the setting of the desired fluorine partial pressure.

The means for thermally activating the fluorine gas or gaseous fluorine compounds can comprise at least parts of the electrode, of a gas distributor assigned to the electrode, of the counter-electrode, of a substrate bearing surface assigned to the counter-electrode, and/or a thermal activation device arranged outside the process chamber.

In accordance with a further advantageous exemplary embodiment, the thermal excitation of the cleaning gas fluorine species can alternatively or additionally be effected by a heating means or temperature-regulating means arranged externally to the process chamber. In this case, it is particularly preferred if the cleaning gas is conducted over a heatable surface prior to entering into the process chamber. In this case, the heatable surface can be, inter alia, a heatable filament or a heatable inlet pipe section.

In the case of the process chambers to be cleaned, it is taken into account that they are often designed for large-area elements to be coated (>1 m²). That means that not only the coating quality but also the cleaning quality can depend on the distance between electrode and counter-electrode. It has thus turned out, for example, that a small distance of 10 to 20 mm is advantageous when the fluorine gas is excited by the electrode or counter-electrode. If a device is provided with which electrode and counter-electrode can be displaced relative to one another, during the cleaning of electrode and/or counter-electrode the distance between the two can be kept small and activated fluorine gas can be introduced into the then narrow gap, such that the surfaces of electrode and counter-electrode facing one another are exposed to fluorine having a relatively high flow density of thermally activated fluorine.

Furthermore, the process chamber is distinguished by the fact that a gas distributor preferably provided with a temperature-regulating means is provided. Such a gas distributor is useful for a homogeneous plasma treatment, for example coating, wherein the temperature-regulating means allows the cleaning of the electrode lying opposite, but also of other components. In one advantageous configuration of the invention, the cleaning gas is conducted into the process chamber via a gas distributor integrated into the electrode, for example a gas distributor for coating gas. In order to ensure a homogeneous gas supply into the process chamber, the gas distributor is provided with a gas exit plate comprising a multiplicity of gas exit openings arranged regularly in a surface.

The temperature-regulating means, assigned for example to the electrode and/or counter-electrode, are advantageously temperature-regulated (by open-loop or closed-loop control), for example with the aid of a temperature-regulating liquid circulating in a circuit. Heat transfer oils which are kept at a temporarily constant temperature for example by recirculating thermostats situated outside the process chamber are preferably used in this case.

### BRIEF DESCRIPTION OF THE DRAWINGS

The invention is explained in greater detail below on the basis of an exemplary embodiment illustrated in the figures, in which:

FIG. 1 shows a longitudinal section through an apparatus for the plasma treatment of a substrate that is to be cleaned according to the invention;

FIG. 2 shows a graphical illustration of an etching rate for a thermally activated fluorine/nitrogen mixture at different total partial pressures of the fluorine or fluorine-containing gas components as a function of the temperature of the cleaning gas.

### DETAILED DESCRIPTION

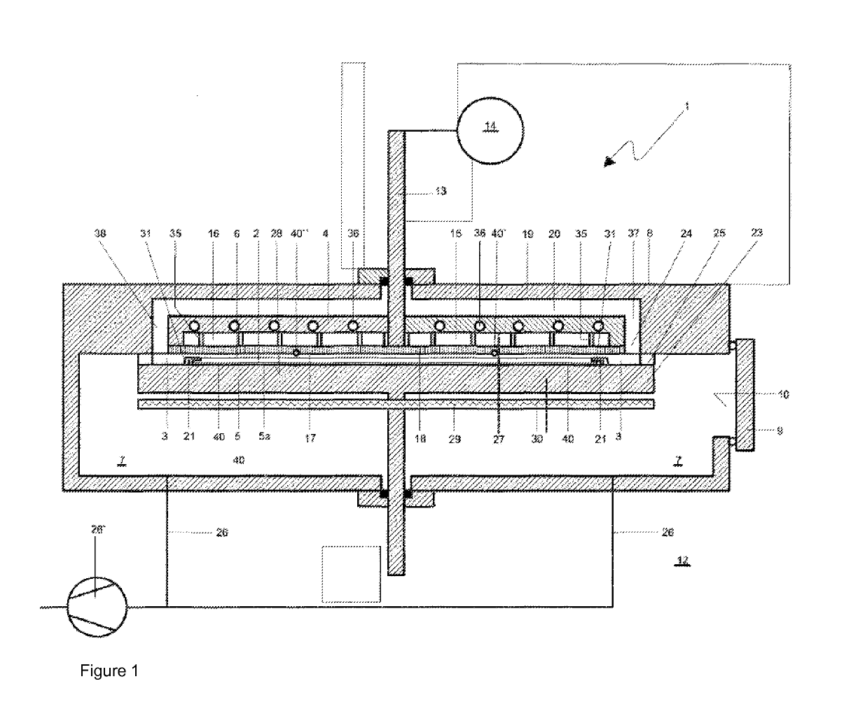

FIG. 1 shows a schematic illustration of a preferred reactor 1 for the treatment of flat substrates 2. The reactor can be configured, in particular, as a PECVD reactor. The reactor 1 comprises a process chamber 3 having an electrode 4 and a counter-electrode 5 for generating a plasma with the aid of which a surface of a substrate 2 can be treated, in particular coated. The electrodes 4, 5 are embodied as large-area metal plates and, for the purpose of generating an electric field in the process chamber 3, can be connected to a voltage source (not illustrated in FIG. 1), preferably a radio frequency supply source having an excitation frequency of between 1 MHz and 150 MHz, preferably 13.56 MHz. Preferably, the electrodes and further components are formed from a fluorine-resistant material (in particular metal) or have a coating composed of a fluorine-resistant material.

The reactor 1 is suitable for the treatment of large-area flat substrates, for example having an area of 1 m² or larger. In particular, the reactor 1 is suitable for carrying out processing steps during the production of high-efficiency thin-film solar modules, for example for amorphous or microcrystalline silicon thin-film solar cells.

As can be seen from FIG. 1, the two electrodes 4, 5 form two opposite walls of the process chamber 3. The process chamber 3 is arranged in a vacuum chamber 7 having an evacuatable housing 8 having an opening 10 for introducing and discharging substrates. The chamber opening 10 is closable in a vacuum-tight manner by a closure apparatus 9. In order to seal the vacuum chamber 7 from the external space 12, seals 11 are provided. In this case, the seals are preferably formed from a fluorine-resistant material for this purpose. The vacuum chamber 7 can have any desired spatial form and can have, in particular, a round or rectangular cross section. The process chamber 3 embedded into the vacuum chamber 7 can have, in particular, the form of a flat cylindrical disk or of a flat parallelepiped. It goes without saying that the invention can also be used in the case of differently configured reactors, in particular with a different process chamber geometry and/or electrode geometry. It likewise goes without saying that embodiments in which the process chamber itself is a vacuum chamber are also encompassed by the invention.

The electrode 4 is arranged in a holding structure 37 in the vacuum chamber 7, which is formed by the housing rear wall 19 in the exemplary embodiment in FIG. 1. For this purpose, the electrode 4 is accommodated in a cut-out 38 in the housing rear wall 19 and separated from the latter by a dielectric 20.

The counter-electrode 5 has, on its side facing the electrode 4, an apparatus 21 for mounting a substrate. The apparatus 21, preferably embodied as a fixing apparatus, comprises as mounting means one or a plurality of holding-down devices 31, which can press a substrate marginally onto the surface 5a of the counter-electrode 5 that functions as a substrate bearing surface. The mounting means can be embodied in finger-like or frame-like fashion. In particular, the mounting means are mechanically connected to the counter-electrode 3, but at the same time electrically and/or thermally insulated from the latter. In particular, at a temperature of the counter-electrode 3 or of the substrate bearing surface 5a of >350° C., the temperature of the mounting means can be in a range of between 20° C. and 100° C.

As can be seen from FIG. 1, the counter-electrode 5, during the performance of the treatment, covers the cut-out 38 of the holding structure 37 in such a way that a gap 25 is formed between the edge region 23 of the counter-electrode 5 and an edge region 24 of the cut-out 38. The gap 25 has a width of the order of magnitude of approximately 1 mm. The gap width is dimensioned in such a way that, on the one hand, during the performance of the treatment, a plasma can be maintained in the interior of the process chamber 3, but, on the other hand, an excessively large pressure gradient is not established between the process chamber 3 and the rest of the interior of the vacuum chamber 7.

For the purpose of coating or etching the substrates, a reactive gas is conducted into the process chamber 3. For this purpose, the reactive gas is fed from a source via a feed channel 13 to a gas distributor 15, from which it flows into the process chamber 3. In the present exemplary embodiment, the gas distributor 15 comprises a gas space 16, which, at the side facing the counter-electrode 5, has a gas exit plate 17 provided with a multiplicity of exit openings (not illustrated) for passing through gas. On an area of approximately 1.0 m²-2.0 m² of the gas exit plate 17 there are typically thousands of exit openings provided.

Selected surfaces or components can be covered during the plasma treatment. The covering can be effected by structural-mechanical covering means or structural-electrical covering means, wherein the latter use the fact that contamination does not take place when a surface lies in the region of a dark space shield, in which no plasma can form. By way of example, no contamination in the gap 25 takes place.

In the apparatus in FIG. 1, the substrate 2 is arranged on a substrate bearing surface 5a during the plasma treatment. In this case, in particular, the substrate bearing surface is covered by the substrate, such that it is not contaminated. In particular, the covering by the substrate 2 can be effected in such a way that the formation of a residue on the substrate bearing surface 5a is prevented during the plasma treatment. In an embodiment of the invention which is embodied in a manner deviating from FIG. 1, the counter-electrode 5 has no or an end region 23 which only slightly goes beyond the region of the gas spray, such that no contamination takes place in this respect.

Regions of the vacuum chamber 7 which are arranged outside the process chamber 3 are connected to a vacuum pump 26′ by vacuum lines 26, such that, during the operation of the vacuum pump 26′, on account of the larger volume of the vacuum chamber 7, it is possible to achieve a high homogeneity of the gas flows from the process chamber 3 via the gap 25 into the vacuum chamber 7 in a simple manner.

The process chamber 3 is provided with control means with a pump apparatus and a control device, which are designed to provide a fluorine-containing cleaning gas having a partial pressure of gaseous fluorine compounds of more than 5 mbar, preferably in a range of between 20 mbar and 1000 mbar, in the process chamber 3 at least temporarily and in partial regions.

It goes without saying that generally no substrate is accommodated in the process chamber during the cleaning. In order to clean the process chamber 3 or else the vacuum chamber 7, the cleaning gas is conducted into the process chamber 3. For this purpose, the cleaning gas is fed from a source 14 via a feed channel, for example the channel 13, preferably to the gas distributor 15, from which it flows into the process chamber 3. Preferably, the source 14 and/or the feed channel are/is designed to be pressure-resistant for a fluorine partial pressure of more than 5 mbar, preferably more than 20 mbar, 100 mbar, 500 mbar or 1000 mbar.

In one variant of the method, the cleaning gas can be pumped out during the cleaning. In another variant, the process chamber 3 is flooded with the cleaning gas during a cleaning time interval and it is only at a later point in time that said gas is pumped out.

In order to achieve a particularly good cleaning result, heating or temperature-regulating means 27, 29, 30 are provided in the reactor 1. With the aid of said means 27, 29, 30, during the cleaning process, the thermal energy supply to the electrode 4 and/or to the counter-electrode 5 or to the bearing surface 5a is controlled by open-loop or closed-loop control. It has been found in experiments that it suffices to arrange the temperature-regulating apparatus only at one of the electrodes, for example at the electrode 4 or counter-electrode 5. The thermal excitation of the cleaning gas at the temperature-regulated electrode 4 or counter-electrode 5 gives rise to a sufficient number of fluorine radicals to clean the opposite (counter-) electrode 5, 4 as well.

In the exemplary embodiment in FIG. 1, temperature-regulating means assigned to the electrodes 4, 5 are provided, wherein the temperature-regulating means of the counter-electrode 5 comprise an apparatus 29 arranged below the counter-electrode 5 in the vacuum chamber 7. With the aid of said apparatus 29, the counter-electrode 5, in particular the substrate bearing surface 5a, can be temperature-regulated in such a way that optimum cleaning can be achieved. The substrate bearing surface 5a has advantageously not been contaminated as a result of the emplaced substrate 2, and so this component was not cleaned. As a result of a small distance between the surface 5a heated to temperatures of >350° and the electrode 4 and respectively the gas distributor 15, electrode 4 and gas distributor 15 can be cleaned very effectively without having to have a temperature higher than in a range of between 20° C. and 80° C. during the cleaning.

In principle, a temperature-regulating apparatus can also be provided for the electrode 4.

Alternatively, an electrode 4 and/or counter-electrode can also be provided in the case of which the apparatus 29 is embodied in a manner integrated with the electrode 4, 5.

In order to determine the magnitude of the required temperature-regulating power of the apparatuses 27, 29 or 30, it is possible to carry out measurements in which the electrodes 4, 5 are provided with thermal sensors 40, 40′ on their sides facing one another. With the aid of said thermal sensors 40, 40′, for different RF powers, gas flows, etc., it is possible to determine a local temperature of the electrodes 4, 5 as a function of the power of the temperature-regulating apparatus 27, 29, 30. On the basis of such measurements, it is possible to optimize the instantaneous temperature-regulating power, if necessary also the geometrical configuration of the temperature-regulating apparatuses 27, 29, 30. Furthermore, during the cleaning, measured values of the thermal sensors 40, 40′ can be obtained and used for process-concomitant closed-loop control of the power of the temperature-regulating apparatuses 27, 29, 30.

Alongside the temperature-regulating apparatuses 27, 29, 30, which can be used equally for one or both of the electrodes 4, 5, the electrode 4 can also be brought into contact or brought to a desired temperature by means of heated gas introduced via the gas distributor 15. In this case, it is advantageous, in particular, if the cleaning gas itself is used for this purpose. Said cleaning gas can be heated, for example, by means of a feed channel 13 that can be heated by means of a temperature-regulating means, or can be conducted over a heatable surface or a heatable filament.

In addition, the gas exit plate 17 can also be temperature-regulated. For this purpose, the gas exit plate 17 can be connected to the electrode 4 with the aid of webs 35 composed of a material having a high thermal conductivity, such that the gas exit plate 17 is thermally linked to the electrode 4. The electrode 4 (and therefore also the gas exit plate 17) can also be temperature-regulated during the cleaning by virtue of the fact that a temperature-regulating liquid circulates through channels 36 in the electrode 4. The temperature of the electrode 4 can be regulated by open-loop or closed-loop control. In particular, thermal sensors 40′ can be arranged in the region of the gas exit plate 17, the measured values of said thermal sensors being used for the closed-loop control of the throughflow of the temperature-regulating means through the electrode 4.

Etching rates of the method according to the invention are compared below with the etching rates of a conventional method.

In the case of the etching methods to be compared, in each case a process chamber for depositing silicon thin films for photovoltaics which is coated with 4.5 μm of μc—silicon or amorphous silicon is taken as a basis. The coating can generally consist of one of the conventional silicon compounds used in solar cells, such as e.g. silicon dioxide, silicon oxide nitride and/or silicon nitride. In this case, the coating occurs primarily on the electrode 4, which comprises a gas distributor. The electrode is temperature-regulated to approximately 60° C. by means of the temperature-regulating apparatuses; the counter-electrode to approximately 200° C. The distance between the electrodes is 14 mm in the case of the coating, and the areas of the electrodes are approximately 2 m² in each case.

a) Conventional Method (Remote Plasma, 3 kW, Microwave):

A remote plasma device (from R3T; excitation with microwave) is flanged to the reactor at the end side. The distance between the two electrodes is increased from 14 mm to 180 mm and excited NF3 flows through a hole into the process chamber with parallel flow to the electrode surfaces. The gas flow rate is 2 slm (standard liters per minute). The pressure in the chamber during the etching process is 2 mbar. The etching operation is ended after 45 minutes. A visual inspection of the reactor shows uniformly clean surfaces. The duration of the etching process was determined by means of the residual gas analysis: as soon as SiF4 was no longer produced, the etching process was ended.

b) Method according to the Invention:

The distance between the electrodes is 14 mm. The cleaning gas composed of 20% F2 in N2 is introduced into the process chamber with a flow rate of 18 slm via the gas spray (gas distributor) integrated into the electrode—without said gas being excited in this case by any type of electrical discharge. In this case, the valve to the process gas pump is closed to an extent such that a constant process chamber pressure of 250 mbar is established after 15 minutes, given a total process chamber volume of 510 liters. The gas mixture with the gas flow rate of 18 slm remains in the boiler for a further 15 minutes. Afterward, the flow rate was set to 0 slm and the gas mixture was pumped out of the boiler within a further 10 minutes. The boiler was then opened and examined visually for remaining silicon coatings. The result was a completely clean boiler. Surprisingly, not only had the 200° C. hot counter-electrode been etched clean, but the comparatively cold electrode at 60° C. had also been completely cleaned. According to the invention, the F2 gas is excited at the hot counter-electrode and is then still enough excited enough at the colder electrode to still etch effectively here as well. In this case, a small distance between the electrodes of approximately 14 mm is advantageous.

After a total time of 40 minutes (gas inlet to pumping out) in the case of the method according to the invention b), the 4.5 μm coating on electrode and on gas spray had been completely removed. The method according to the invention is therefore faster than the conventional cleaning by means of an R3T remote plasma device with a power of 3 kW and an NF3 flow rate of 2 slm.

As was mentioned under b), it can be established that the thermal excitation of the fluorine radicals by the heated counter-electrode suffices to provide advantageously fast and complete cleaning results. This is also verified by an examination of the etching rate of a fluorine/nitrogen mixture as a function of the temperature of a surface to be etched.

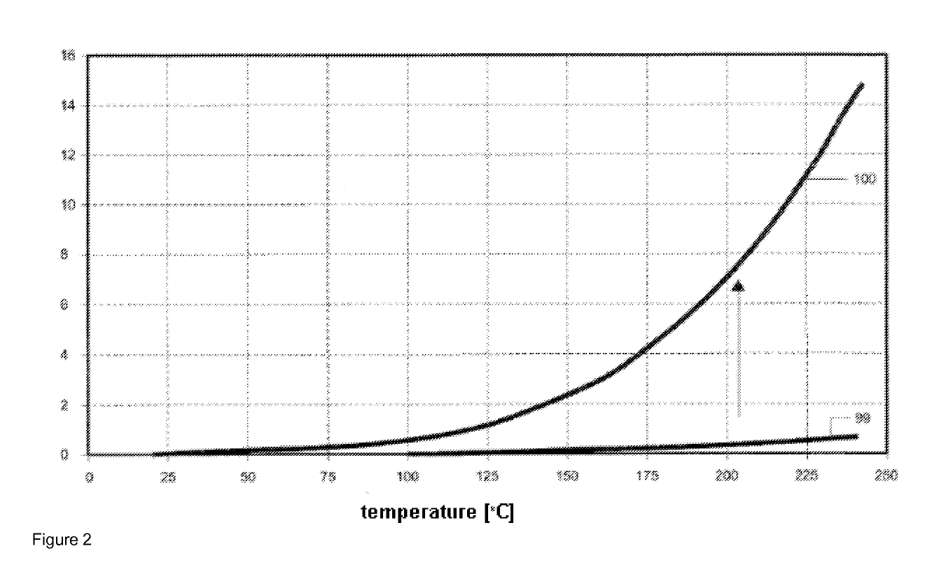

FIG. 2 shows a graphical illustration in which the etching rate during etching of a thermally activated fluorine/nitrogen mixture in nm/s (y-axis) is plotted against the temperature in ° C. (x-axis). A fluorine/nitrogen mixture having a partial pressure of 250 mbar is chosen in this case.

The graph 100 illustrated in FIG. 2 shows that the etching rate rises greatly starting from a temperature of approximately 100° C. at a partial pressure of 250 mbar in comparison with etching at conventional low pressures of at most 1 mbar, wherein, at values above 150° C., an etching rate of more than 8 nm/s is achieved. The etching rate has then already been tripled at temperatures around 200° C.

It is therefore advantageous to bring one of the electrodes to a temperature that is as high as possible, wherein consideration should be given to structural prerequisites and restrictions, in order not to shorten the lifetime of the plate reactor or of the electrodes or of some other component. A good compromise has proved to be a temperature of approximately 200° C., which exhibits a significant etching rate. The other electrode preferably has a lower temperature, for example in a range of between 20° C. or 60° C. and 100° C., preferably at most 15% relative to the temperature during the plasma treatment, for example the plasma coating of substrates.

1. A method for cleaning a surface of at least one component arranged in an inner region of a process chamber by means of exposure to a cleaning gas comprising fluorine gas, wherein the process chamber has at least one electrode and counter-electrode for generating a plasma for the plasma treatment of a substrate, the method comprising:
exposing the component to be cleaned to fluorine gas or gaseous fluorine compounds with a total partial pressure of greater than 5 mbar
and/or
thermally activating the fluorine gas or gaseous fluorine compounds and
regulating the temperature of the component to be cleaned to a temperature of <350° C.

2. The method as claimed in claim 1, wherein the inner region is exposed to fluorine gas or gaseous fluorine compounds with a total partial pressure of greater than 5 mbar.

3. The method as claimed in claim 1, wherein, prior to exposure to the cleaning gas, by means of the plasma treatment, a substrate is coated with a layer comprising silicon or silicon-containing compounds and a residue comprising silicon silicon-containing compounds is preferably formed on the component to be cleaned.

4. The method as claimed in claim 1, wherein, prior to exposure to the cleaning gas by means of the plasma treatment, a substrate is etched and a residue comprising silicon or silicon-containing compounds is formed at least on the component to be cleaned.

5. The method as claimed in claim 1, wherein at least one partial region of the electrode, of the counter-electrode, of a gas distributor assigned to the electrode, of a substrate bearing surface assigned to the counter-electrode or of a boiler wall surface of the process chamber is chosen as the surface to be cleaned and/or, during exposure to the cleaning gas, the surface to be cleaned has a temperature which is at most 1.8 times the temperature of the surface during the plasma treatment.

6. The method as claimed in claim 5, further comprising preventing formation of a residue on a surface region of the electrode, of the counter-electrode, of the gas distributor, of the substrate bearing surface and/or of a boiler wall surface of the process chamber, by structural-mechanical or structural-electrical covering means.

7. The method as claimed in claim 6, further comprising covering the substrate bearing surface by a substrate in such a way that the formation of a residue on the substrate bearing surface is prevented during the plasma treatment.

8. The method as claimed in claim 7, wherein at least partial surfaces of mounting means are chosen as the surface to be cleaned, wherein the mounting means are assigned to the substrate bearing surface.

9. The method as claimed in claim 1, wherein at least parts of the electrode and/or of a gas distributor assigned to the electrode are used as means for thermally activating the fluorine gas and/or the gaseous fluorine compounds.

10. The method as claimed in claim 1, wherein at least parts of the counter-electrode and/or of a substrate bearing surface assigned to the counter-electrode are used as means for thermally activating the fluorine gas or the gaseous fluorine compounds.

11. The method as claimed in claim 1, wherein alongside fluorine gas an inert gas is used in the cleaning gas.

12. The method as claimed in claim 1, wherein a plasma excitation of the cleaning gas within and/or outside the process chamber and/or a thermal activation outside the process chamber are/is effected.

13. The method as claimed in claim 1, wherein during exposure to the cleaning gas, a distance in a range of between 2 mm and 100 mm is set between a gas exit plate of a gas distributor assigned to the electrode and a substrate bearing surface assigned to the counter-electrode.

14. A process chamber having at least one electrode and counter-electrode for generating a plasma for plasma treatment of a substrate, configured to perform a method as claimed in claim 1, the chamber comprising:
means for exposing the component to be cleaned to fluorine gas or gaseous fluorine compounds with a total partial pressure of greater than 5 mbar
and/or
means for thermally activating the fluorine gas or gaseous fluorine compounds and for regulating the temperature of the component to be cleaned to a temperature of <350° C.

15. The process chamber as claimed in claim 14, wherein the means for thermally activating the fluorine gas or gaseous fluorine compounds comprise at least parts of the electrode, of a gas distributor assigned to the electrode, of the counter-electrode, of a substrate bearing surface assigned to the counter-electrode, and/or a thermal activation device arranged outside the process chamber.

16. The process chamber as claimed in claim 14, further comprising covering means for preventing the formation of a residue during a plasma treatment on a surface region of the electrode, of a counter-electrode, of the gas distributor and/or of the substrate bearing surface.

17. The process chamber as claimed in claim 16, further comprising a substrate bearing surface assigned to the counter-electrode which can be covered during the plasma treatment of a substrate in such a way that formation of a residue on the substrate bearing surface can be prevented during the plasma treatment.
